(19) United States
(12) Patent Application Publication
(10) Pub. No.: US 2025/0315054 A1
(43) Pub. Date: Oct. 9, 2025

(54) SYSTEM AND METHOD OF AN ADAPTIVE MAPPING SYSTEM FOR AUTONOMOUS ROBOTS FOR IMPROVED NAVIGATION

(71) Applicant: Avidbots Corp, Kitchener (CA)

(72) Inventors: Florentin Christoph VON FRANKENBERG, Bright (CA); Marc Jerome GALLANT, Waterloo (CA); Brent William HANNIMAN, Waterloo (CA); Naveena PANDILLAPALLY, London (CA); Jaime Andres SALAZAR POSADA, Cali (CO); Thuvaragan VITHIYANANTHAN, Brampton (CA); Mitchel Esteban COLLAZOS AGREDO, Cauca (CO)

(21) Appl. No.: 19/174,450

(22) Filed: Apr. 9, 2025

Related U.S. Application Data
(60) Provisional application No. 63/631,552, filed on Apr. 9, 2024.

(51) Int. Cl. G05D 1/246; A47L 11/40; G05D 105/10; G05D 109/10; G05D 111/10; G05D 111/50

(52) U.S. Cl. CPC G05D 1/2464; A47L 11/4011; A47L 2201/04; G05D 2105/10; G05D 2109/10; G05D 2111/17; G05D 2111/52; G05D 2111/54

(57) ABSTRACT

A system and method of an adaptive mapping system for semi-autonomous cleaning devices for improved navigation using a randomized dot pattern to represent dynamic areas and ensure precise localization in changing environments. A map is parameterized as an occupancy grid, where each cell is assigned the likelihood that it contains a physical object in the environment. A novel mapping technique is disclosed that intelligently distinguishes between static features (e.g., walls and pillars) and dynamic areas (e.g., places prone to frequent changes). By representing dynamic areas with a randomized dot pattern, an adaptive mapping system maintains high localization confidence for autonomous mobile robots (AMRs). This approach ensures uninterrupted robot operations, significantly reducing or eliminating the need for human intervention due to localization uncertainties and addresses the critical problem of navigating and operating efficiently in environments that undergo frequent changes.

### CROSS REFERENCE TO RELATED APPLICATIONS

This application claims priority to and the benefit of U.S. Provisional Patent Application Ser. No. 63/631,552, entitled “SYSTEM AND METHOD OF AN ADAPTIVE MAPPING SYSTEM FOR AUTONOMOUS ROBOTS FOR IMPROVED NAVIGATION” filed on Apr. 9, 2024, the disclosure of which is incorporated herein by reference in its entirety.

### BACKGROUND

The embodiments described herein relate to semi-autonomous cleaning devices, in particular to a system and method for mapping and navigation of autonomous robots and/or semi-autonomous cleaning devices.

There is a significant challenge in the field of robotics, specifically concerning the navigation and localization of Autonomous Mobile Robots (AMRs) within dynamic environments. Traditional mapping systems for robots rely on static representations of environments, mapping out objects and features as they were at the time of the mapping process. These static maps are used by robots to navigate spaces, relying on their localization algorithms to compare real-time sensory data (like lidar scans) against the map to determine their precise location.

However, this traditional approach encounters difficulties in environments where the position of objects and features frequently changes. Common scenarios include warehouses where inventory moves regularly, factories with shifting machinery, or retail spaces undergoing layout modifications. In such settings, the static nature of conventional maps quickly becomes outdated, leading to a mismatch between the robot's sensory perceptions and its map. This discrepancy can cause the robot's localization algorithm to lose confidence in determining the robot's position accurately, potentially halting operations and necessitating human intervention to reorient or update the robot's understanding of its environment.

The two primary strategies traditionally employed to mitigate this issue are:
1. Enhancing Localization Algorithms: Making them more tolerant to discrepancies between the map and the real-world environment. While advancements in this area have improved robots' ability to navigate in slightly altered spaces, they ultimately rely on a degree of map accuracy to function effectively, especially for path planning and specific tasks.
2. Frequent Map Updating: Keeping the map as reflective of the current environment as possible through regular updates. This approach is only viable if environmental changes are gradual and infrequent enough to allow for timely updates. In highly dynamic settings, the rapid pace of change can outstrip the ability to update maps, rendering this strategy ineffective.

There is a desire to overcome these issues (or limitations) by having autonomous mobile robots (AMRs) or cleaning devices intelligently distinguish between static features and dynamic areas.

### SUMMARY

A system and method of an adaptive mapping system for semi-autonomous cleaning devices or robots for improved navigation using a randomized dot pattern to represent dynamic areas and ensure precise localization in changing environments. A map is parameterized as an occupancy grid, where each cell is assigned the likelihood that it contains a physical object in the environment. A novel mapping technique is disclosed that permits distinguishing between static features (e.g., walls and pillars) and dynamic areas (e.g., places prone to frequent changes). By representing dynamic areas with a randomized dot pattern, an adaptive mapping system maintains high localization confidence for autonomous mobile robots (AMRs). This approach ensures uninterrupted robot operations, significantly reducing or eliminating the need for human intervention due to localization uncertainties and addresses the critical problem of navigating and operating efficiently in environments that undergo frequent changes.

A method for distinguishing between permanent and changeable areas or features in an environment, to guide which features are used as references for localization. The method is a simple approach of a new map style, which distinctly represents only static features with solid lines and depicts dynamic areas with a randomized dot pattern, the localization algorithm consistently maintains confidence in the robot's position.

### BRIEF DESCRIPTION OF THE DRAWINGS

FIG. 1 is a diagram illustrating a perspective view of an exemplary semi-autonomous cleaning device.

FIG. 2 is a diagram illustrating the front view of the semi-autonomous cleaning device.

FIG. 3 is a diagram illustrating the back view of the semi-autonomous cleaning device.

FIG. 4 is a diagram illustrating the left-side view of a semi-autonomous cleaning device.

FIG. 5 is a diagram illustrating the right-side view of a semi-autonomous cleaning device.

FIG. 6 is a diagram illustrating localization with a normal map for the exemplary semi-autonomous cleaning device.

FIG. 7 is a diagram illustrating localization with a probabilistic map for the exemplary semi-autonomous cleaning device.

FIG. 8 is a close-up diagram illustrating localization of the probabilistic map for the exemplary semi-autonomous cleaning device.

FIG. 9 is a flowchart illustrating the processing steps of the semi-autonomous cleaning device.

FIG. 10 is a flowchart illustrating scan alignment of the semi-autonomous cleaning device.

FIG. 11 is a flowchart illustrating scan alignment in a localization monitor of the semi-autonomous cleaning device.

FIG. 12 is a block diagram illustrating the system of the exemplary semi-autonomous cleaning device.

### DETAILED DESCRIPTION

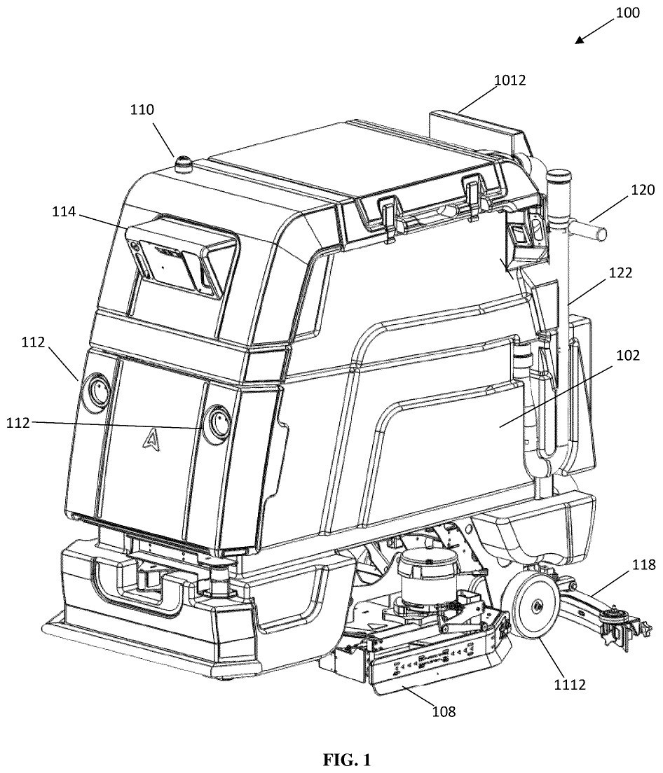

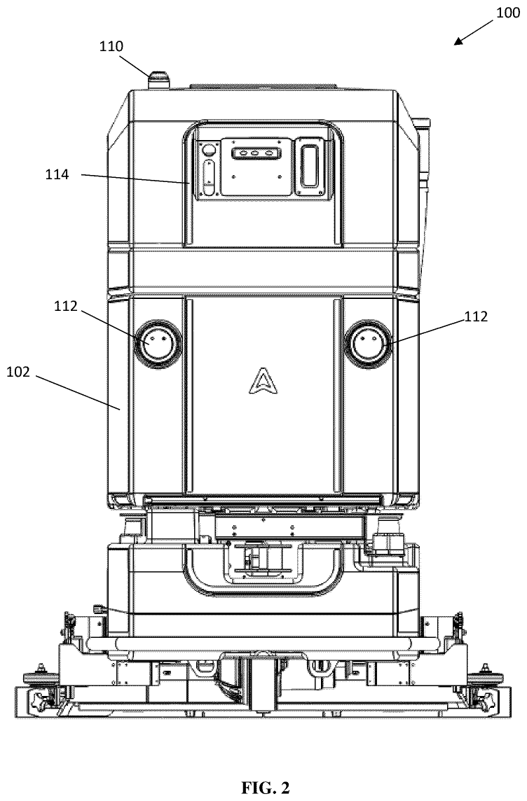

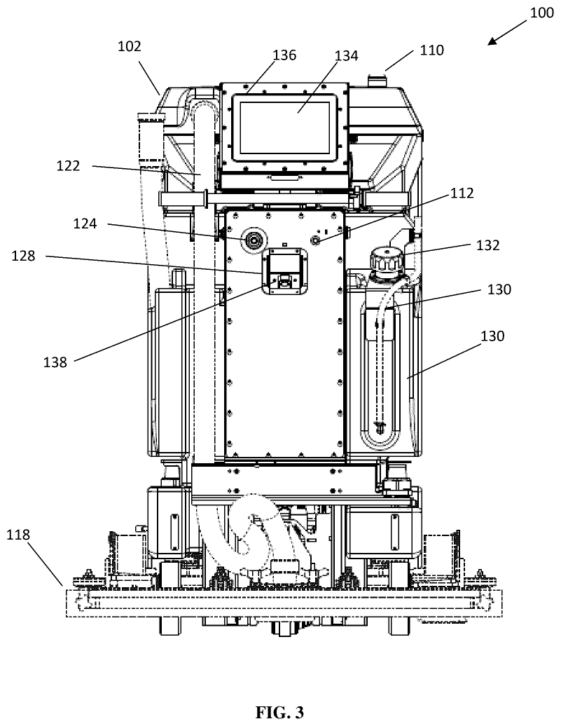

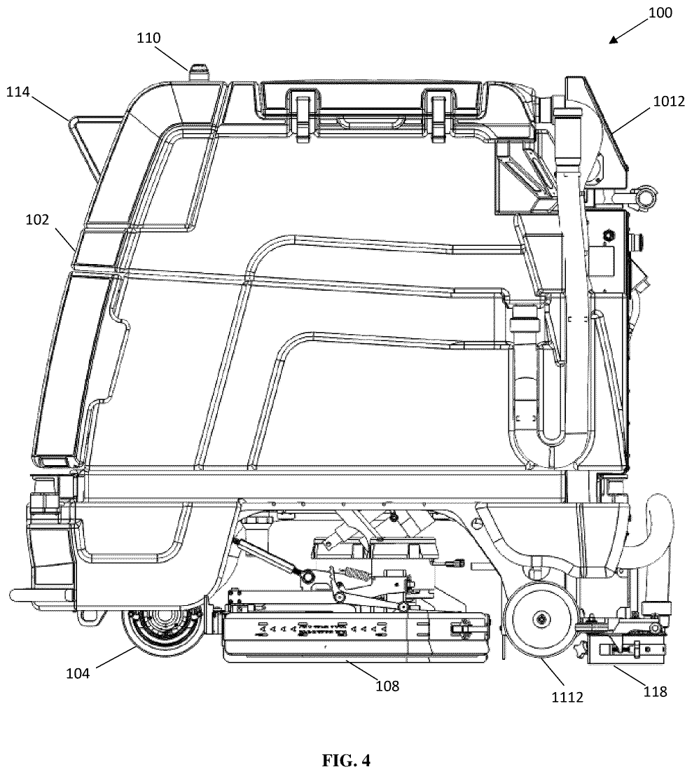

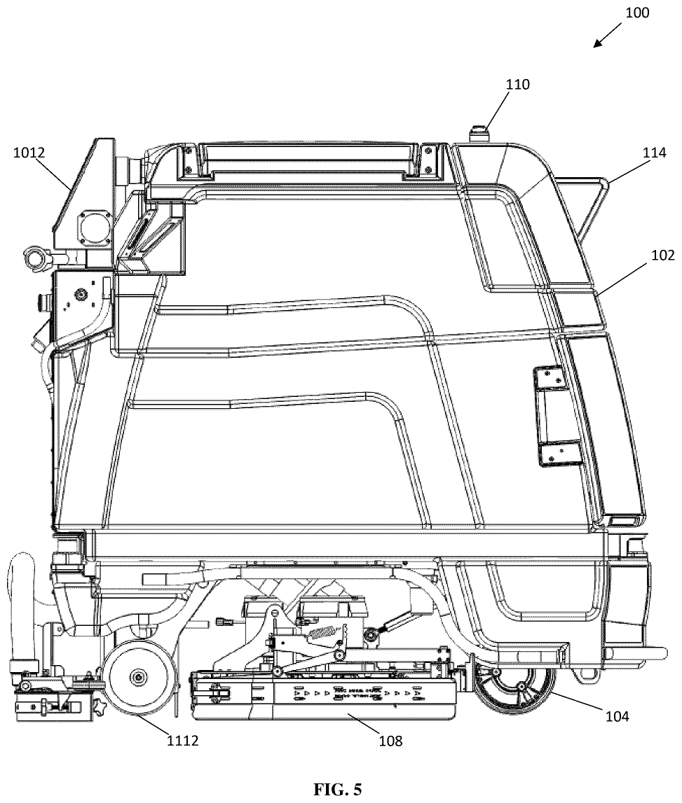

An exemplary embodiment of an autonomous or semi-autonomous cleaning device is shown in FIGS. 1-5. FIG. 1 is a perspective view of a semi-autonomous cleaning device. FIG. 2 is a front view of a semi-autonomous cleaning device. FIG. 3 is a back view of a semi-autonomous cleaning device. FIG. 4 is a left side view of a semi-autonomous cleaning device, and FIG. 5 is a right-side view of a semi-autonomous cleaning device.

FIGS. 1 to 5 illustrate a semi-autonomous cleaning device 100. The device 100 (also referred to herein as “cleaning robot” or “robot”) includes at least a frame 102, a drive system 104, an electronics system 106, and a cleaning assembly 108. The cleaning robot 100 can be used to clean (e.g., vacuum, scrub, disinfect, etc.) any suitable surface area such as, for example, a floor of a home, commercial building, warehouse, etc. The robot 100 can be any suitable shape, size, or configuration and can include one or more systems, mechanisms, assemblies, or subassemblies that can perform any suitable function associated with, for example, traveling along a surface, mapping a surface, cleaning a surface, and/or the like.

The frame 102 of cleaning device 100 can be any suitable shape, size, and/or configuration. For example, in some embodiments, the frame 102 can include a set of components or the like, which are coupled to form a support structure configured to support the drive system 104, the cleaning assembly 108, and the electronic system 106. The cleaning assembly 108 may be connected directly to frame 102 or an alternate suitable support structure or sub-frame (not shown). The frame 102 of cleaning device 100 further comprises a strobe light 110, front lights 112, a front sensing module 114, a rear sensing module 128, rear wheels 116, rear skirt or squeegee 118, an optional handle 120 and cleaning hose 122. The frame 102 also includes one or more internal storage tanks or storing volumes for storing water, disinfecting solutions (i.e., bleach, soap, cleaning liquid, etc.), debris (dirt), and dirty water. More information on the cleaning device 100 is further disclosed in U.S. utility patent application Ser. No. 17/650,678, entitled “APPARATUS AND METHODS FOR SEMI-AUTONOMOUS CLEANING OF SURFACES” filed on Feb. 11, 2022, the disclosure which is incorporated herein by reference in its entirety.

More particularly, in this embodiment, the front sensing module 114 further includes structured light sensors in a vertical and horizontal mounting position, one or more sensors (e.g., an active stereo sensor) and a RGB camera. The rear sensing module 128, as seen in FIG. 3, consists of a rear optical camera 138. In further embodiments, front and rear sensing modules 114 and 128 may also include other sensors including one or more optical cameras, thermal cameras, LiDAR (Light Detection and Ranging), structured light sensors, active stereo sensors (for 3D) and RGB cameras or optical cameras.

The back view of a semi-autonomous cleaning device 100, as seen in FIG. 3, further shows a frame 102, cleaning hose 122, clean water tank 130, clean water fill port 132, rear skirt 118, strobe light 110 and an electronic system 134. Electronic system 134 further comprises display 136 which can be either a static display or touchscreen display. Rear skirt 118 consists of a squeegee head or rubber blade that engages the floor surface along which the cleaning device 100 travels.

FIG. 3 further depicts an emergency stop button 124, a device power switch button 126 and a rear sensing module 128. Rear sensing module 128 comprises an optical camera that is positioned to view the area behind device 100. This complements the front sensing module 114 that provides a view in front of device 100. The two sensing modules work together to sense obstacles and obstructions.

### Solution Mechanism

This disclosure emerges as a solution to a critical challenge faced by Autonomous Mobile Robots (AMRs) navigating dynamic environments—maintaining accurate localization despite frequent changes in the layout or positioning of objects. Traditional localization systems rely heavily on comparing real-time sensor data (e.g., lidar scans) against a pre-stored map to pinpoint the robot's location. The Localization Monitor, a pivotal element in our technology, oversees this process. It evaluates the quality of localization by monitoring the congruence between the robot's sensory perception and its internal map. When discrepancies arise—often due to environmental changes—the Localization Monitor triggers a Localization Loss, halting the robot and necessitating manual intervention. This safety measure, while necessary, introduces operational interruptions, especially in environments such as warehouses, factories or retail spaces where changes are common.

According to the disclosure, a novel map representation technique specifically designed to enhance the robot's navigation and localization in environments subject to frequent alterations is disclosed. This technique uniquely distinguishes between static features (such as walls and pillars) that remain constant and dynamic areas where changes are expected (i.e., merchandise layouts in stores or movable equipment in factories). Dynamic areas are depicted with a randomized dot pattern, a method that fundamentally transforms how the robot perceives and interacts with its surroundings.

According to the disclosure, the map is parameterized as an occupancy grid, where each cell is assigned the likelihood that it contains a physical object in the environment. Because this likelihood is often unknown in dynamic areas, a randomized dot pattern of occupied cells is used. This pattern indicates the possibility of occupation, without the need to specify a threshold likelihood at which cells are considered occupied.

The key innovation lies in the map's dual representation, which includes the following:
Static Features are detailed accurately, providing a reliable anchor for the robot's localization system.
Dynamic Areas are represented by a randomized dot pattern, which acknowledges the potential for change without specific details that could become quickly outdated.

This approach significantly augments the ability of the Localization Monitor to discern between actual navigation errors (inaccurate poses) and mere changes in the environment. By accounting for expected variability in dynamic areas, the robot is less likely to trigger Localization Losses due to mismatches between its sensory data and the map. The Localization Monitor, equipped with this nuanced understanding, can maintain higher confidence in the robot's localization accuracy, minimizing unnecessary interruptions.

### Generation of Dot Pattern

The randomization of the dot pattern is central to this invention's efficacy. This is achieved by setting an average density for the dots, for instance, one dot per 0.5 meters squared. The area in question is divided into cells of equal size (0.5 meters squared in this example), and within each cell, a single dot is placed at a random location. This method ensures the maintenance of the specified average density while preventing the formation of any recognizable geometric patterns in the dot placement. Such randomization is vital to prevent the robot's real-time sensor data from aligning preferentially with any specific arrangement of the dots, thereby optimizing the localization algorithm's performance across the dynamic area without bias. The randomized dot pattern is applied to regions of maps which correspond to areas that frequently change. Features which represent objects that are not permanent, like boxes in warehouses, are removed from the map representation and replaced by the randomized dot pattern. Features which are permanent like walls and pillars are maintained, even if they exist within a randomized dot region.

### Solution Diagrams

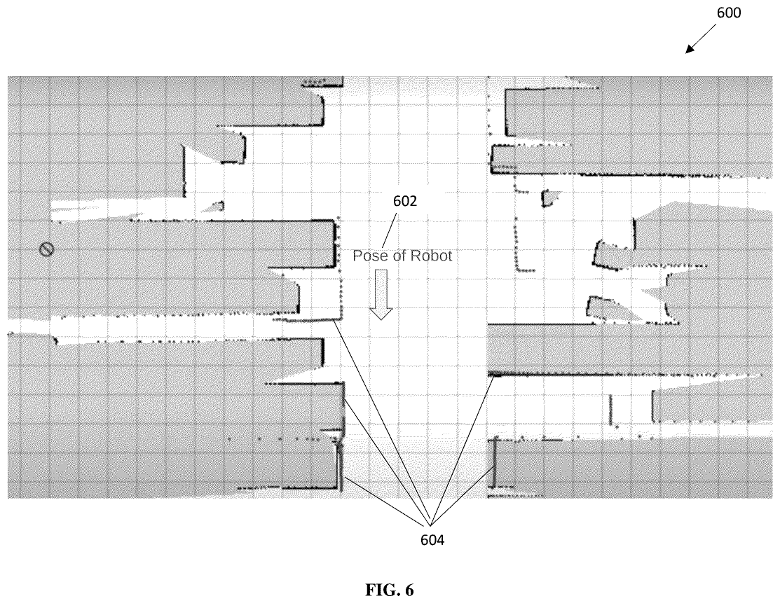

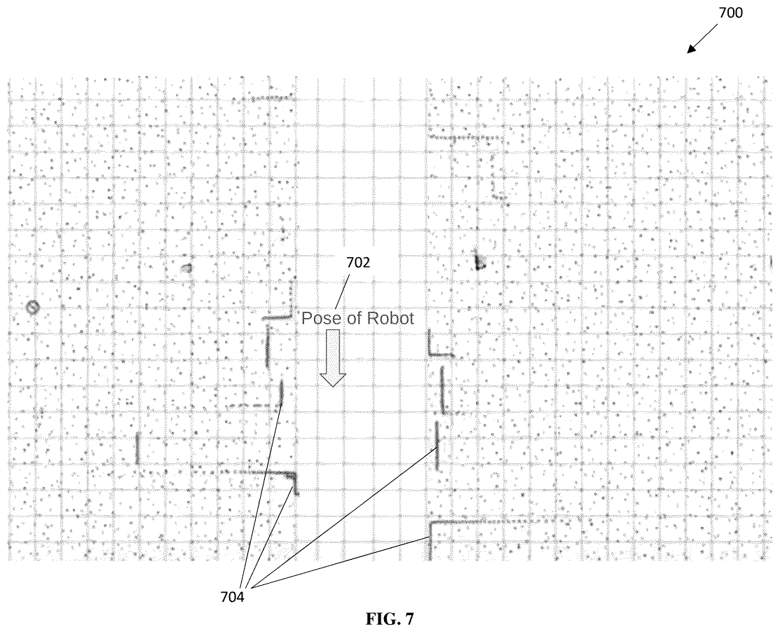

FIG. 6 is a diagram 600 illustrating localization with a normal map for the exemplary semi-autonomous cleaning device. FIG. 7 is a diagram 700 illustrating localization with a probabilistic map for the exemplary semi-autonomous cleaning device. According to FIGS. 6 and 7, the pose of the robot 602 and 702 is indicated by the arrow in the center of the image, showing the robot's position and the direction the robot is facing. Sensors on the autonomous robot provide sensor data 604 and 704 (i.e., darker dots) to what has been maintained as map data 604 and 704 (i.e., darker dots).

The randomized dot pattern in FIG. 7 covers areas where changes are anticipated, while the clear area represents drive aisles that are not expected to have frequent changes. The same area can be seen in FIG. 6 with a normal map provided using black pixels showing the layout of objects as they appeared at the time of mapping. It can be seen that the darker bold dots, representing live sensor data 604, differ significantly from the position of the mapped obstacles. The discrepancy between mapped and live sensor data demonstrates the challenge of environmental change. The Cloudpoint Map in FIG. 7 demonstrates that the majority of live sensor data 704 lie close to a black point, due to the randomized dot pattern. This permits the system to disregard environmental changes in dotted regions.

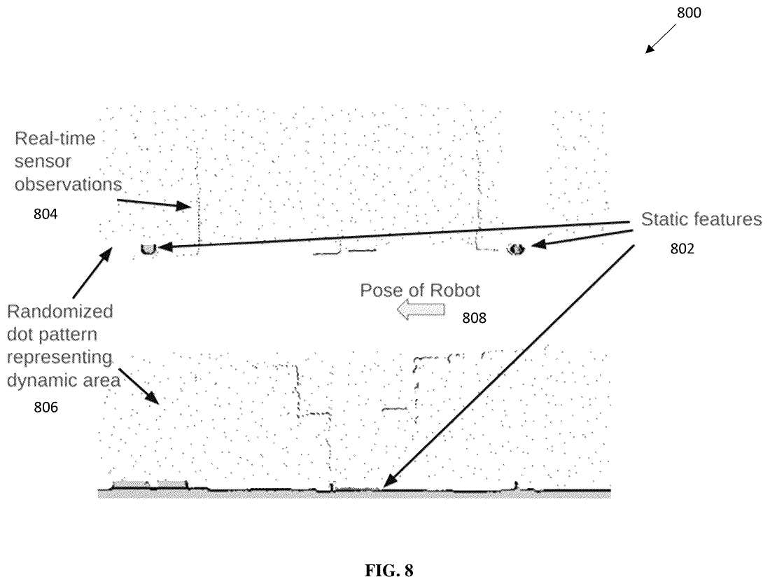

FIG. 8 is a close-up diagram 800 illustrating localization of the probabilistic map for the exemplary semi-autonomous cleaning device. According to FIG. 8, the autonomous robot is located in the pose indicated in the image. Real-time sensor observations 804 are shown as darker bold dots. The randomized dot pattern indicates dynamic areas 806 where the environment is expected to change frequently. Static features 802 are shown as solid black lines. Areas that might change are represented with a randomized dot pattern. When observations differ from the map too far, the semi-autonomous cleaning device or robot will stop. Observations are computed using hardware, including 2-D LIDAR and other sensors for tracking position, wheel encoders and an inertial measurement unit (IMU). The pose of the robot or direction of travel is shown with the arrow 908.

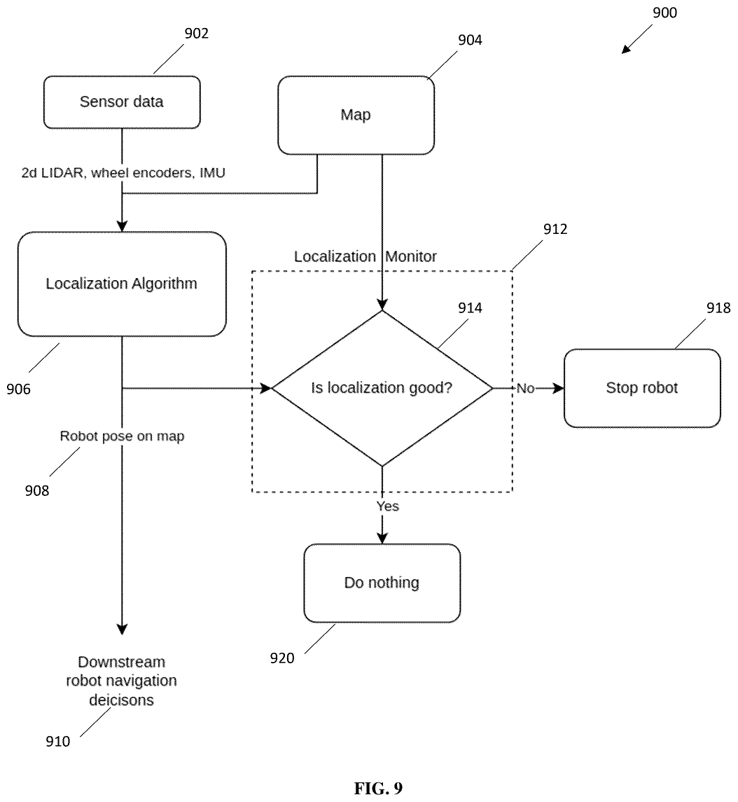

FIG. 9 is a flowchart illustrating the processing steps of the semi-autonomous cleaning device. According to FIG. 9, this high-level flowchart 900 outlines a high-level process detailing how the autonomous robot utilizes live sensor data alongside maps to ascertain its position and orientation, while also assessing the confidence level in the accuracy of this positioning information.

According to FIG. 9, sensor data 902 from the 2D LIDAR, wheel encoders and IMU is provided to the localization algorithm 906. Map data 904 is also provided to the localization algorithm 906. The localization algorithm 906 then provides downstream robot navigation decisions 910 by providing robot pose 908 on the map.

According to FIG. 9, the localization algorithm 906 then moves to the localization monitor 912 which determines whether the localization is good at 914 (or valid). If the localization is not good or valid, the semi-autonomous cleaning device or robot is stopped at 918. If so, do nothing at 912. Furthermore, map data is also provided to the localization monitor to make the decision.

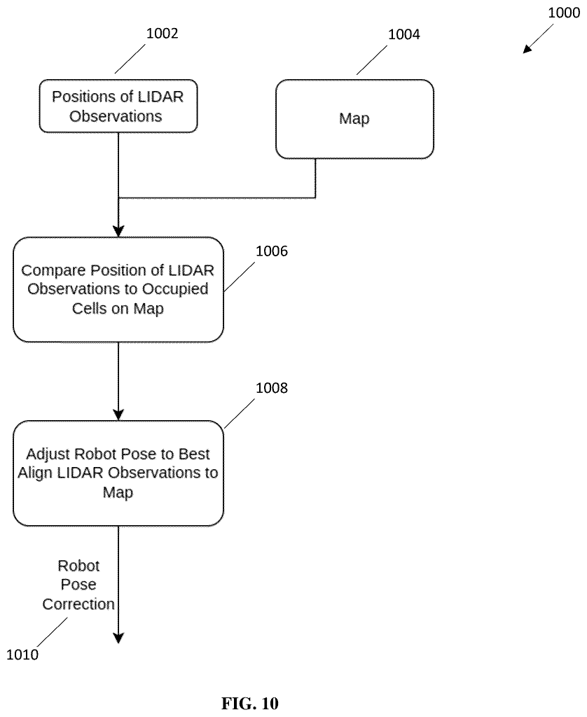

FIG. 10 is a flowchart illustrating scan alignment of the semi-autonomous cleaning device. According to FIG. 10, the flowchart 1000 details the role of Scan Alignment within the Localization Algorithm, a pivotal mechanism for matching LIDAR observations with map features. The randomized dot pattern used in Cloudpoint Maps is intended to neutralize Scan Alignment's influence within these areas, preventing the relocation of objects within dynamic areas from affecting the Localization Algorithm's calculation of the robot's pose.

According to FIG. 10, map data 1004 and positions of the LIDAR observations 1002 is initially provided whereby the position of LIDAR observations to occupied cells on map is compared at 1006. Next, the robot pose to best align LIDAR observations to the map is adjusted at 1008. The output would be a robot pose correction at 1010 which is provided to other systems in the robot or the semi-autonomous cleaning device.

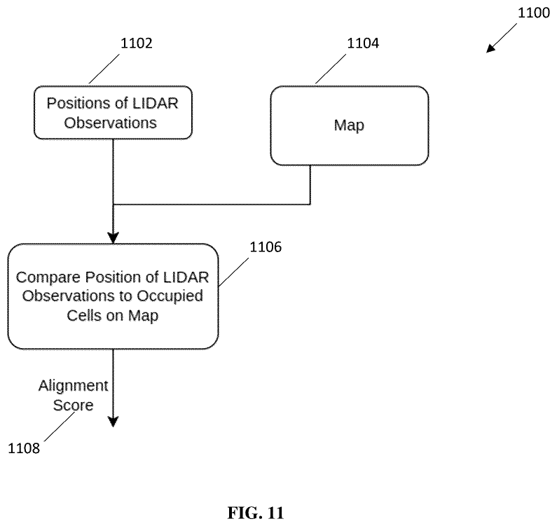

FIG. 11 is a flowchart illustrating scan alignment in a localization monitor of the semi-autonomous cleaning device. According to FIG. 11, this flowchart 1100 illustrates how the Scan Alignment calculation influences the Localization Monitor. Just as Cloudpoint Maps affect the Scan Alignment process within the Localization Algorithm, the presence of a randomized dot pattern ensures a high Scan Alignment score in dynamic regions. This high score maintains the Localization Monitor's confidence, despite the movement of objects within these areas, effectively preventing decreased confidence levels due to environmental changes.

According to FIG. 11, map data 1104 and positions of LIDAR observations 1102 are combined, and the positions of LIDAR observations are compared to occupied cells on map at 1106. The output would be an alignment score 1108.

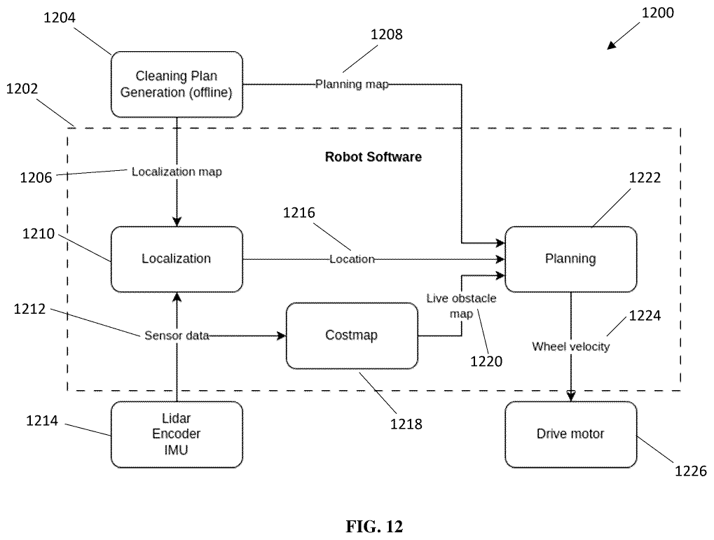

According to the disclosure, FIG. 12 is a block diagram illustrating the system of the exemplary semi-autonomous cleaning device. According to FIG. 12, block diagram 1200 for the semi-autonomous cleaning device comprises a robot software module 1202. The robot software module further comprises a Localization module 1210, a Costmap module 1218 and a Planning module 1222.

According to FIG. 12, input to the robot software module 1202 includes Cleaning Path Generation module 1204 and Lidar Encoder IMU module 1214. The Lidar Encoder IMU module 1214 provides sensor data 1212 to the Localization module 1210 and the Costmap module 1218. The Cleaning Path Generation module 1204 provides localization map data 1206 to the Localization module 1210 and planning map data 1208 to the Planning module 1222. Data from the Cleaning Path Generation module 1204 can be computed and provided offline.

According to FIG. 12, the Localization module 1210 outputs localization data 1216 to the Planning module 1222. The Costmap module 1218 outputs live or real-time obstacle map data 1220 to the Planning module 1222.

According to FIG. 12, all the data (i.e., planning map data 1208, location data 1216 and live obstacle map data 1220) are combined and compiled at Planning module 1222 whereby wheel velocity data 1224 is calculated and sent as output to the Drive motor 1226.

### Operational Benefits

This disclosure directly addresses the problem of operational discontinuity caused by frequent manual recalibrations. With the improved map representation, AMRs can continue their tasks with reduced intervention, enhancing efficiency and productivity. This innovative mapping technique not only bolsters the robots' autonomy but also leverages the existing capabilities of the Localization Monitor, making it a symbiotic enhancement to the overall localization system.

This feature introduces a modification in the way maps are represented for robot localization systems. Typically, the maps used depict the environment with all objects positioned as they were during the mapping process. These maps assist the robot's localization algorithms in pinpointing the robot's location by comparing its lidar scans against the map's features.

However, when the real-world position of objects and other features change—due to factors like renovations or movement of products in warehouses—the map's effectiveness for localization diminishes. To address this, two main strategies are employed:
1. Use more sophisticated localization algorithms that tolerate changes in the environment
2. Try to keep the map as up to date as possible so as to be representative of the current environment

According to the disclosure, localization algorithms of semi-autonomous cleaning devices, such as devices from Avidbots, have become more tolerant to changes and ultimately relate what the cleaning device (or robot) is perceiving back to the map in order to plan paths and clean the areas specified on that map. This necessitates a degree of accuracy in the map.

The second strategy, updating the map regularly, is only feasible if environmental changes are gradual and infrequent enough to allow for timely map updates. In settings like malls, where changes are relatively rare, maps can be updated using data from previous robot runs.

However, in more dynamic environments such as retail spaces, warehouses and factories, the positions of objects and features can change so rapidly that data from previous runs becomes outdated quickly, rendering this approach ineffective.

The newly proposed map representation addresses this challenge by designating areas where environmental changes are anticipated, while still accurately depicting static features such as facility walls and pillars. In this representation, areas prone to regular changes are shown with a randomized dot pattern, whereas static features are depicted in the usual manner.

### Unique Aspects of Cloudpoint Maps

Cloudpoint maps uniquely enable the localization algorithm to abstract away from the minutiae of objects' precise positions in environments like warehouses, where items frequently move. This abstraction is achieved through the use of a randomized dot pattern to represent dynamic areas. One of the primary benefits of this approach is that it allows the localization system to utilize the general vicinity of expected items (e.g., boxes in a warehouse) as reference points for navigation, without relying on their exact placement.

Specifically, the algorithm enhances the robot's alignment within its environment—such as maintaining correct orientation within an aisle—by favoring sensor observations that align with the dynamic dotted areas on the map. This method leverages the natural tendency of the scan alignment algorithm to optimize for observations that coincide with marked points (i.e., the dots), effectively guiding the robot's navigation within dynamically changing spaces. This principle is central to Cloudpoint maps and underpins its innovative approach to robotic localization.

Detection of devices or robots utilizing Cloudpoint maps technique could be inferred through observation of their robots' navigation behavior in dynamic environments. Specifically, if a device or robot maintains consistent localization accuracy without frequent stops for reorientation in areas with high object turnover—demonstrating an ability to navigate efficiently between areas marked by a seemingly random pattern of dots—it might suggest the use of a Cloudpoint-like mapping strategy.

According to further embodiments, an alternative approach to achieving similar goals without using Cloudpoint maps might involve modifying the localization algorithm to interpret a new map layer with designated priorities. For example, maps could be annotated to highlight regions where the precision of object placements should be deprioritized in the localization process. Unlike the direct method of using a randomized dot pattern in Cloudpoint maps, this workaround could adjust the algorithm to interpret greyscale objects with varying impacts on the localization score and alignment.

By assigning different greyscale values to areas of the map, the algorithm could selectively adjust the weight of sensor observations in these areas, effectively mimicking the functional outcome of Cloudpoint maps by de-emphasizing the exact placement of objects in dynamic environments. This method offers a nuanced, algorithm-based strategy to handle changes in the environment by recalibrating the importance of specific observations during localization, thereby maintaining operational efficiency and accuracy in dynamic settings.

According to further aspects of the disclosure, the map used for localization may differ from the map for path planning and/or the map for remote monitoring, thus these maps should be modified appropriately. For example, the localization map should be modified as described above (i.e., density of points representing likelihood of obstacle presence), but the planning maps should be modified using a different formula for obstacle permanence instead of this scattering of points. Furthermore, the map for remote monitoring may show the localization map information in a different colour, or may use another means to indicate that it is an area with changing obstacle layouts, to assist with remote pose corrections.

According to further aspects of the disclosure, depending on the size of the pose correction, the system can correct errors (i.e., differences between IMU, wheel odometry, and lidar scan matching means of localization) in the reported pose in different ways. For example:
Automatically while the robot is moving if the adjustment is small, or
Automatically but after the semi-autonomous cleaning device or robot is stopped, so the robot can safely correct the path it is following relative to the updated localization belief, if the adjustment is large.

According to the disclosure, a computer-implemented method for calculating improved navigation in a changing environment for a semi-autonomous cleaning apparatus is disclosed. The semi-autonomous cleaning apparatus comprises a processor, a plurality of sensors, navigation hardware and navigation software.

The computer-implemented method comprises the steps of receiving live or real-time sensor data from sensors of the semi-autonomous cleaning apparatus, receiving map data from the semi-autonomous cleaning apparatus, sending the sensor data and map data to a localization algorithm, calculating a robot pose on the map for the semi-autonomous cleaning apparatus, receiving the robot pose at a localization monitor and determining whether the localization is valid.

According to the disclosure, if the localization is valid, do nothing and if the localization is not valid, stop the semi-autonomous cleaning apparatus. Finally, the computer-implemented method sends the robot pose to the hardware and navigation software of the semi-autonomous cleaning apparatus to determine navigation decisions. The live or real-time sensor data is combined with the map data to determine the position and orientation of the semi-autonomous cleaning apparatus.

According to the disclosure, the sensor data of the computer-implemented method is received from the plurality of sensors and further comprises 2D LIDAR data, 3D LIDAR data, wheel encoder data, or inertial measurement unit (IMU) data. The live or real-time sensor data of the computer-implemented method is combined with the map data and is further configured to assess the confidence level in the accuracy of positioning information.

According to the disclosure, the map data of the computer-implemented method is Cloudpoint map data. The Cloudpoint map data further comprises randomized dot pattern data. The randomized dot pattern data is used to represent dynamic areas and ensure precise localization in the changing environment. The map of the computer-implemented method is parameterized as an occupancy grid, wherein each cell is assigned the likelihood that it contains a physical object in the environment.

According to the disclosure, the method is used as a mapping technique that intelligently distinguishes between static features and dynamic areas. The static features includes walls and pillars and dynamic areas that further comprises areas that are prone to change frequently. The dynamic areas are represented by randomized dot patterns whereby an adaptive mapping system used by the semi-autonomous cleaning apparatus maintains a high localization confidence.

According to the disclosure, a computer-implemented method for scan alignment of a semi-autonomous cleaning apparatus is disclosed The semi-autonomous cleaning apparatus comprising a processor, a plurality of sensors, navigation hardware and navigation software.

The scan alignment method comprises the steps of receiving positions of LIDAR observations from the semi-autonomous cleaning apparatus, receiving map data from the semi-autonomous cleaning apparatus, comparing the position of the LIDAR observations to the occupied cells on the map, adjusting the robot pose to best align the LIDAR observations to the map and providing the robot pose correction to the hardware and navigation software of the semi-autonomous cleaning apparatus.

According to the disclosure, the scan alignment method is computed within a localization algorithm configured for matching LIDAR observations with features of the map. The map data of the scan alignment method is a Cloudpoint map. The Cloudpoint map data further comprises randomized dot pattern data. The randomized dot pattern used in Cloudpoint Maps is configured to balance the scan alignment influence within the scan areas, thereby preventing the relocation of objects within dynamic areas from affecting the localization algorithm's calculation of the robot's pose.

According to the disclosure, a computer-implemented method for scan alignment of a localization monitor of a semi-autonomous cleaning apparatus is disclosed. The computer-implemented method comprises the steps of receiving positions of LIDAR observations from the semi-autonomous cleaning apparatus, receiving map data from the semi-autonomous cleaning apparatus, comparing the position of the LIDAR observations to the occupied cells on the map and calculating an alignment score.

According to the disclosure, the alignment score influences the localization monitor wherein a high score maintains the localization monitor's confidence, despite the movement of objects within these areas, effectively preventing decreased confidence levels due to environmental changes.

According to the disclosure, the map data of the computer-implemented method is Cloudpoint map and the Cloudpoint map data further comprises randomized dot pattern data. Furthermore, the presence of a randomized dot pattern ensures a high scan alignment score in dynamic regions.

According to the disclosure, a system for calculating improved navigation in a changing environment for a semi-autonomous cleaning apparatus is disclosed, the system comprises a processor, one or more LIDAR sensors or cameras configured for obstacle detection, one or more motors or actuators configured for movement of the cleaning apparatus, a cleaning plan generation module configured to provide localization map data and planning map data and a plurality of navigation software modules.

According to the disclosure, the plurality of navigation software modules of the system further comprises a localization module, a costmap module and a planning module. The plurality of navigation software module are further configured to send live or real-time sensor data from the cleaning plan generation module to the localization module, send sensor data to the localization module and the costmap module, send map data from the cleaning plan generation module to the planning module, compute location data at the localization module and sending it to the planning module, compute live obstacle map data at the costmap module and send it to the planning module, combine and process the planning map data, the location data and the live obstacle map data the planning module to compute wheel velocity data and send the wheel velocity data to the motors or actuators to drive or move the semi-autonomous cleaning apparatus.

According to the disclosure, the sensor data of the system is received from the plurality of sensors and further comprises 2D LIDAR data, 3D LIDAR data, wheel encoder data, or inertial measurement unit (IMU) data. The live or real-time sensor data of the system is combined with the map data and is further configured to assess the confidence level in the accuracy of positioning information.

According to the disclosure, the map data of the system is Cloudpoint map data and wherein the Cloudpoint map data further comprises randomized dot pattern data. The randomized dot pattern data is used to represent dynamic areas and ensure precise localization in the changing environment. The map of the system is parameterized as an occupancy grid, wherein each cell is assigned the likelihood that it contains a physical object in the environment.

According to the disclosure, the system utilizes a mapping technique that intelligently distinguishes between static features and dynamic areas. Furthermore, the static features of the system comprises walls and pillars, the dynamic areas of the system comprises areas that are prone to change frequently and the dynamic areas are represented by randomized dot patterns whereby an adaptive mapping system used by the semi-autonomous cleaning apparatus maintains a high localization confidence.

According to the disclosure, the cleaning plan generation data of the system can be generated and provided offline.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A computer-implemented method for calculating improved navigation in a changing environment for a semi-autonomous cleaning apparatus, the semi-autonomous cleaning apparatus comprising a processor, a plurality of sensors, navigation hardware and navigation software, the method comprising the steps of:
receiving live or real-time sensor data from sensors of the semi-autonomous cleaning apparatus;
receiving map data from the semi-autonomous cleaning apparatus;
sending the sensor data and map data to a localization algorithm;
calculating a robot pose on the map for the semi-autonomous cleaning apparatus;
receiving the robot pose at a localization monitor and determining whether the localization is valid;
if the localization is valid, do nothing; and
if the localization is not valid, stop the semi-autonomous cleaning apparatus;
sending the robot pose to the hardware and navigation software of the semi-autonomous cleaning apparatus to determine navigation decisions;
wherein the live or real-time sensor data is combined with the map data to determine the position and orientation of the semi-autonomous cleaning apparatus.

2. The computer-implemented method of claim 1 wherein the sensor data is received from the plurality of sensors and further comprises 2D LIDAR data, 3D LIDAR data, wheel encoder data, or inertial measurement unit (IMU) data.

3. The computer-implemented method of claim 1 wherein the live or real-time sensor data is combined with the map data and is further configured to assess the confidence level in the accuracy of positioning information.

4. The computer-implemented method of claim 1 wherein the map data is Cloudpoint map data and wherein the Cloudpoint map data further comprises randomized dot pattern data.

5. The computer-implemented method of claim 4 wherein the randomized dot pattern data is used to represent dynamic areas and ensure precise localization in the changing environment.

6. The computer-implemented method of claim 1 wherein the map is parameterized as an occupancy grid, wherein each cell is assigned the likelihood that it contains a physical object in the environment.

7. The computer-implemented method of claim 1 wherein the method is used as a mapping technique that intelligently distinguishes between static features and dynamic areas.

8. The computer-implemented method of claim 7 wherein the static features includes walls and pillars and dynamic areas further comprises areas that are prone to change frequently.

9. The computer-implemented method of claim 7 wherein dynamic areas are represented by randomized dot patterns whereby an adaptive mapping system used by the semi-autonomous cleaning apparatus maintains a high localization confidence.

10. A computer-implemented method for scan alignment of a semi-autonomous cleaning apparatus, the semi-autonomous cleaning apparatus comprising a processor, a plurality of sensors, navigation hardware and navigation software, the method comprising the steps of:
receiving positions of LIDAR observations from the semi-autonomous cleaning apparatus;
receiving map data from the semi-autonomous cleaning apparatus;
comparing the position of the LIDAR observations to the occupied cells on the map;
adjusting the robot pose to best align the LIDAR observations to the map; and
providing the robot pose correction to the hardware and navigation software of the semi-autonomous cleaning apparatus.

11. The computer-implemented method of claim 10 wherein scan alignment is computed within a localization algorithm configured for matching LIDAR observations with features of the map.

12. The computer-implemented method of claim 10 wherein the map data is a Cloudpoint map, the Cloudpoint map data further comprising randomized dot pattern data.

13. The computer-implemented method of claim 10 wherein the randomized dot pattern used in Cloudpoint Maps is configured to balance the scan alignment influence within the scan areas, thereby preventing the relocation of objects within dynamic areas from affecting the localization algorithm's calculation of the robot's pose.

14. A system for calculating improved navigation in a changing environment for a semi-autonomous cleaning apparatus comprising:
a processor;
one or more LIDAR sensors or cameras configured for obstacle detection;
one or more motors or actuators configured for movement of the cleaning apparatus;
a cleaning plan generation module configured to provide localization map data and planning map data;
a plurality of navigation software modules, the plurality of navigation software modules further comprising:
a localization module;
a costmap module; and
a planning module;
wherein the plurality of navigation software module are further configured to:
send live or real-time sensor data from the cleaning plan generation module to the localization module;
send sensor data to the localization module and the costmap module;
send map data from the cleaning plan generation module to the planning module;
compute location data at the localization module and sending it to the planning module;
compute live obstacle map data at the costmap module and send it to the planning module;
combine and process the planning map data, the location data and the live obstacle map data the planning module to compute wheel velocity data; and
send the wheel velocity data to the motors or actuators to drive or move the semi-autonomous cleaning apparatus.

15. The system of claim 14 wherein the sensor data is received from the plurality of sensors and further comprises 2D LIDAR data, 3D LIDAR data, wheel encoder data, or inertial measurement unit (IMU) data.

16. The system of claim 14 wherein the live or real-time sensor data is combined with the map data and is further configured to assess the confidence level in the accuracy of positioning information.

17. The system of claim 14 wherein the map data is Cloudpoint map data and wherein the Cloudpoint map data further comprises randomized dot pattern data.

18. The system of claim 15 wherein the randomized dot pattern data is used to represent dynamic areas and ensure precise localization in the changing environment.

19. The system of claim 14 wherein the map is parameterized as an occupancy grid, wherein each cell is assigned to the likelihood that it contains a physical object in the environment.

20. The system of claim 18,
wherein the static features comprises walls and pillars;
wherein the dynamic areas comprises areas that are prone to change frequently;
wherein the dynamic areas are represented by randomized dot patterns whereby an adaptive mapping system used by the semi-autonomous cleaning apparatus maintains a high localization confidence.
